(19) United States
(12) Patent Application Publication
(10) Pub. No.: US 2011/0041774 A1
(43) Pub. Date: Feb. 24, 2011

(54) Pet Kennel with Mesh Top

(75) Inventors: Melaney Northrop, Mansfield, TX (US); Adam Weber, Keller, TX (US)

Correspondence Address: DORSEY & WHITNEY, LLP;INTELLECTUAL PROPERTY DEPARTMENT, 1400 Wewatta Street, Suite 400, DENVER, CO, 80202-5549, US

(73) Assignee: Doskocil Manufacturing Company, Inc., Arlington, TX (US)

(21) Appl. No.: 12/845,664

(22) Filed: Jul. 28, 2010

Related U.S. Application Data
(60) Provisional application No. 61/213,905, filed on Jul. 28, 2009.

(51) Int. Cl. A01K 1/03; B23P 11/00

(52) U.S. Cl. 119/497; 119/499; 119/500; 29/428

(57) ABSTRACT

A kennel for an animal having a base and a top. The base includes a base rim extending from the base and surrounding an upper perimeter of the base. The top is a mesh material and includes a top rim surrounding a bottom perimeter of the top. The top rim is configured to align with the bottom rim. The kennel also includes at least one fastener to secure the top rim to the bottom rim, as well as a rotatable door connected to the base and the top.

### CROSS-REFERENCE TO RELATED APPLICATION

This application claims the benefit of U.S. Provisional Patent Application Ser. No. 61/213,905, filed Jul. 28, 2009, entitled “Pet Kennel With Mesh Top,” which is incorporated by reference herein in its entirety and for all purposes.

### TECHNICAL FIELD

Embodiments discussed herein generally relate to animal traveling and containment apparatuses and, more specifically, to pet kennels and crates.

### BACKGROUND OF THE INVENTION

Pets often times need to be caged or otherwise prevented from accessing certain areas. Additionally, pets often need to be contained in order to be transported. One option is a crate or kennel for the animal. Kennels provide an area for the animal to stand, sit and/or sleep, while at the same time containing the animal inside. Kennels often are made of plastic and may have a solid top and bottom, as well as a movable door to allow the pets to enter and exit. However, as many kennels have a solid plastic top, the owner (as well as other people) can be prevented from easily viewing the pet inside the kennel. Likewise, the pet may not easily be able view outside of the kennel. Further, the solid tops may hinder air circulation and prevent adequate ventilation for the animal within the kennel.

### BRIEF SUMMARY OF THE INVENTION

Certain embodiments take the form of a kennel for an animal having a base and a top. The kennel may also have a base rim extending from the base and surrounding an upper perimeter of the base. The top may be made of mesh. A top rim may surround a bottom perimeter of the top and be configured to align with the bottom rim. At least one fastener may be configured to secure the top rim to the bottom rim. A door may be rotatably connected to the base and the top.

Other embodiments include a crate for an animal having a base and a top configured to be secured to the base. The top includes a top panel, and first and second side panels. The top panel, and the two side panels are operatively connected together. Also, the crate includes a lip operatively connected to the first and second side panels, the lip receives and substantially surrounds a bottom of the first and second side panels.

Still other embodiments include a method for constructing a kennel for an animal. The method includes forming a plastic base. Stamping a mesh material forming a top, the top includes an upper panel and at least one side panel. Forming at least one rib, the at least one rib secures the upper panel and the least one side panel together. Surrounding a bottom edge of the at least one side panel with a metal material. Folding the metal material on top of the bottom edge creating a rim around a bottom edge of the least one side panel.

While multiple embodiments are disclosed, still other embodiments of the present invention will become apparent to those skilled in the art from the following detailed description, which shows and describes illustrative embodiments. As will be realized, embodiments disclosed herein are capable of modifications in various aspects, all without departing from the spirit and scope of the present disclosure. Accordingly, the drawings and detailed description are to be regarded as illustrative in nature and not restrictive.

### BRIEF DESCRIPTION OF THE DRAWINGS

FIG. 1 is a perspective view of a kennel.

FIG. 2 is a front view of the kennel illustrated in FIG. 1.

FIG. 3 is a side view of the kennel illustrated in FIG. 1.

FIG. 4 is a top view of the kennel illustrated in FIG. 1.

FIG. 5 is a perspective view of a second embodiment of a kennel top.

FIG. 6 is a perspective view of a third embodiment of a kennel top.

FIG. 7A is a top view of a fourth embodiment of a kennel top.

FIG. 7B is a perspective view of the kennel illustrated in FIG. 7A where a hatch is in an open position.

FIG. 8 is a front perspective view of a fifth embodiment of a top.

FIG. 9 is an rear perspective view the kennel illustrated in FIG. 8 with its hatch in an open position.

FIG. 10A is a perspective view of a sixth embodiment of a top with the cover in an open position.

FIG. 10B is a perspective view of the kennel illustrated in FIG. 10A with the cover in an a closed position.

FIG. 11 is a flow chart illustrating operations for creating the kennel illustrated in FIG. 1.

### DETAILED DESCRIPTION

Disclosed herein is a kennel to be used to transport and contain pets. The kennel has a base and a top or cover. In some embodiments the base and the top are made of different materials. For example, the top may be made of a mesh that attaches to the bottom base. Mesh, as used herein, may refer to any stamped, rolled, extruded, expanded, punched, woven materials and the like, including those made from metal. The mesh may permit the pet to view and be viewed by people outside of the kennel, as well as providing increased air circulation throughout the kennel when compared to solid top kennels. The top may include various strengthening beams and/or braces to provide strength and support to the mesh. The ribs may help to prevent the mesh from warping or becoming misshapen, for example. In some embodiments the top may be combined with non-mesh elements, creating a patchwork-like appearance.

A handle may be attached to the top to allow the kennel to be more easily carried. The kennel may also include a door providing an entry and exit for the animal; this door may be configured to swing sideways or upwards to open and may be removable. In addition to the door, some embodiments of the kennel may include a hatch or a second door, thereby allowing the animal to enter and exit the kennel via the top or back of the kennel. In some embodiments the kennel may have a top-loading door (e.g., a hatch) either in addition to or instead of the door. The door and/or hatch may be configured to latch or otherwise be secured to the kennel, thus preventing the door and/or hatch from inadvertently opening. The top and base of the kennel may be separable and stackable inside one another when not in use. In these embodiments the door may be removable, allowing the top and bottom to separate. Additionally, in some embodiments the top and bottom are secured together (when assembled) via fasteners.

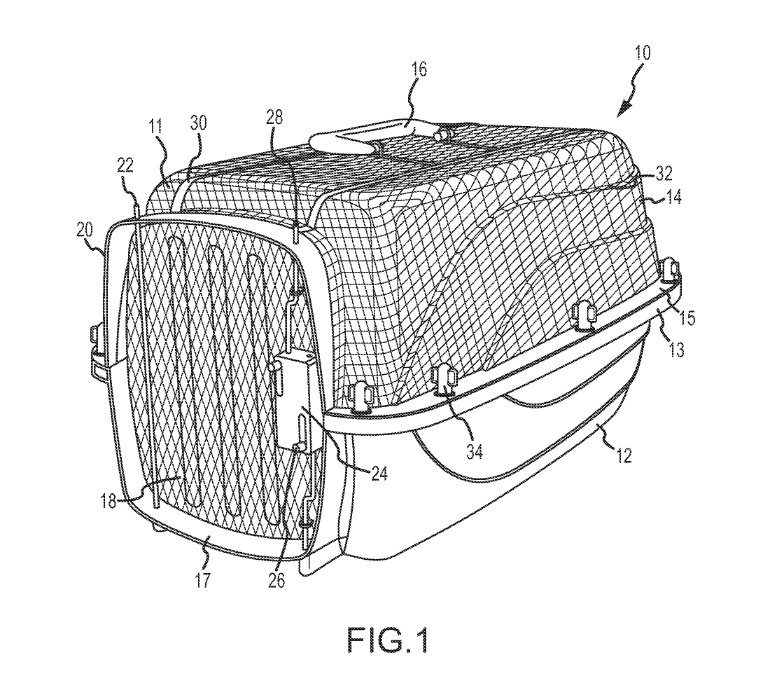

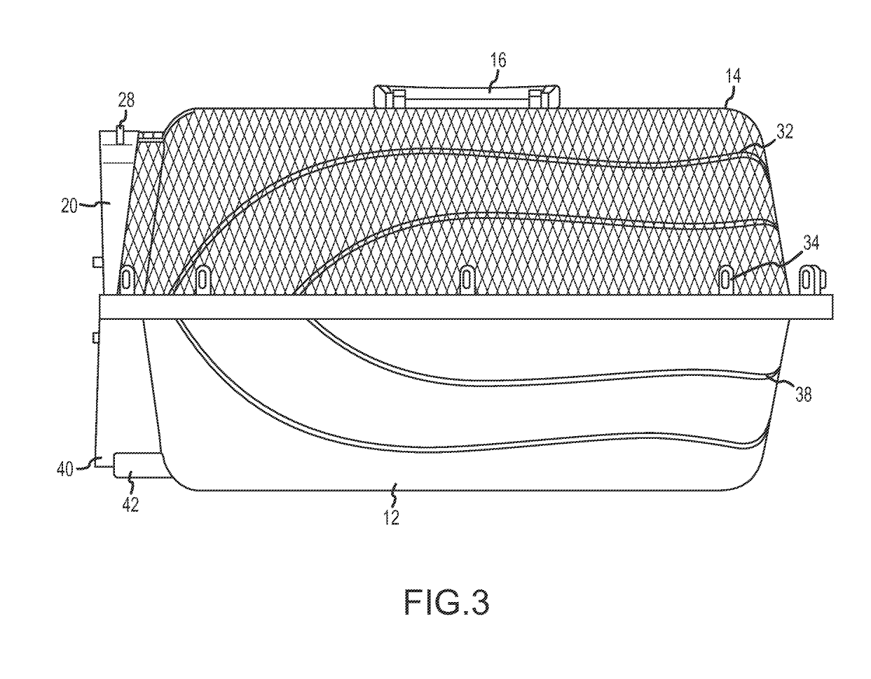

FIG. 1 is a perspective view of a first embodiment of the kennel, and FIG. 3 is a side elevation view of the kennel 10. Referring to FIGS. 1 and 3, the kennel 10 includes a top 14 and a base 12. A door 18 extends between a projection 40 in the base 12 and a frame 20 connected to the top 14. The door 18 is secured to the frame 20 and base 12 via a hinge rod 22. Optional latching rods 28 may be selectively engaged with either the frame and/or projection to securely close the door. When a user wishes to open the door, he may push tabs attached to the latching rods toward a centerline of the door, thereby disengaging the rods from the frame and/or base. Other embodiments may use different mechanisms to selectively engage and disengage the latching rods, such as a knob, twist turn, handle and so on.

The kennel 10 may also include a handle 16 attached to the top 14 assisting in the transportation of the kennel 10. The kennel 10 may substantially vary in size, depending on the different animals it is designed to accommodate. For example, a kennel designed to hold a cat may be smaller than a kennel sized for a large dog. Accordingly, in some embodiments the overall dimensions of the various elements may be reduced, while keeping the basic design of the kennel 10 the same.

The top 14 and the base 12 may be two separate and separable pieces. Thus, the top 14 may be secured to the base 12 via fasteners 34. As shown in FIG. 1 the fasteners 34 may be intermittently spaced along a rim 15 on the top 14 and secure to the bottom of a rim 13 on the base 12. Additionally, the top 14 and base 12, when removed from each other may be stackable, i.e. the top 14 may be turned upside down and the upper surface of the top 14 may be placed within the base 12. Alternative mechanisms may be used to join the top and bottom, such as clips, post and groove/aperture arrangements, mating channels, and so on.

The base 12 is typically, although not necessarily, solid and may be created out of a variety of materials. In some embodiments the base 12 is a hard plastic such as acrylonitrile butadiene styrene, polytetrafluoroethylene, polyvinyl chloride, polyvinyl ethylene, thermosettable plastics and the like. The base 12 may be generally rectangular such that the ends have a shorter width and/or length than the sides. However, in other embodiments the base 12 may be a variety of shapes, such as circular, square, and the like. The shape of the base 12 may correspond to the shape of the top 14 at least at the point of connection or otherwise may mimic the shape of the connection area of the top 14. For example, the top 14 may be rounded at its upper portion, but have a rectangular bottom, while the base's shape may only correspond to the bottom (rectangular) shape of the top 14 instead of the top's 14 overall shape.

A bottom surface of the base 12 supports the kennel and the inside surface of the bottom of the base 12 provides a surface for the animal to sit, stand or lie. In some instances, the bottom of the base 12 may include a layer of padding or the like to provide a comfortable place for the animal. However, in other embodiments the bottom of the base 12 may lack any such extra layer. Typically, but not necessarily, the bottom is formed from the same material as the outer portions of the base 12. The dimensions of the base 12 may be altered to accommodate a variety of animals. For instance, if the kennel 10 is designed to be used for cats, the base 12 may be smaller than if the kennel 10 is designed to be used for large dogs. Additionally, as the bottom surface of the base 12 may be solid (e.g., Tacking any apertures). Thus, substances such as animal waste or the like may be substantially prevented from leaking outside of the kennel 10. These embodiments may allow the kennel 10 to be used to transport the animal via various methods of transportation, such as airplanes, trains and the like where waste leakage may be an issue.

The base 12 may include indentations 38 along its sides. The indentations 38 may add an aesthetic element to the base 12 and may also strengthen and/or stiffen it. The top of the base 12 may have a rim 13 extending around the perimeter. The rim 13 may be substantially flat along its upper surface in order to provide a planar connection area for the top 14. In some embodiments, the rim 13 includes apertures (not shown) configured to receive the fasteners 34 connecting the base 12 and the top 14. The rim 13 may be integrated with the base 12 or separately attached.

The front side of the base 12 may form a cutout or hollow, thereby creating an opening on the front side of the base. A protrusion 40 extends from the front side of the base 12 at the cutout area and defines an edge of an entry/exit point for the animal. The protrusion 40 connects to the rim 13 and extends downwards, forming a flat lip or edge at the base 12. The protrusion 40 may be raised higher than a bottom portion of the base 12 and may include legs 42 or pegs supporting the protrusion 40 and the base 12. The door 18 connects to the protrusion 40 via the aforementioned hinge rod 22 and latching rods 28, all of which may extend into or through apertures (not shown) on an upper facing surface of the protrusion 40. The protrusion 40 may serve to define the lower edge of the animal's entry/exit point.

The top 14 is secured to the base 14 by fasteners 34 or other means, and substantially encloses the base 14 to create an internal cavity. The top 14 may be substantially rectangular shaped with an opening on its front face. However, in other embodiments, the top 14 may be any of a variety of shapes. The top 14 typically has a bottom shape complementary to the rim 13 surrounding the base 12, such that the top 14 may rest along the rim 13 and be secured to the base 12.

The top 14 is often formed from a mesh material, such as stamped metal or the like. The mesh material for the top 14 may be wire-like and created out of metal, plastic, a combination of metal and plastic and the like. The mesh may include multiple tubes or tube-like elements connected in a honeycomb or other pattern. The material may have numerous apertures within its surface, such that material required for the top 14 is less than what would be required if the top 14 was solid. Furthermore, the apertures allow the top 14 to be substantially see-through, such that the inside area of the kennel 10 is visible outside of the kennel 10. The increased visibility of the kennel 10 may comfort the animal placed inside the kennel 10 as the animal may be able to see its surroundings. Similarly, the visibility of the mesh allows owners and others to view inside the kennel 10 quickly, without having to open the door or remove the animal. The apertures in the top 14 also allow air to circulate between the outside of the kennel 10 and the inside of the kennel 10. Allowing more air into the kennel 10 may create a better environment for the animal as well as helping to reduce smells within the kennel 10.

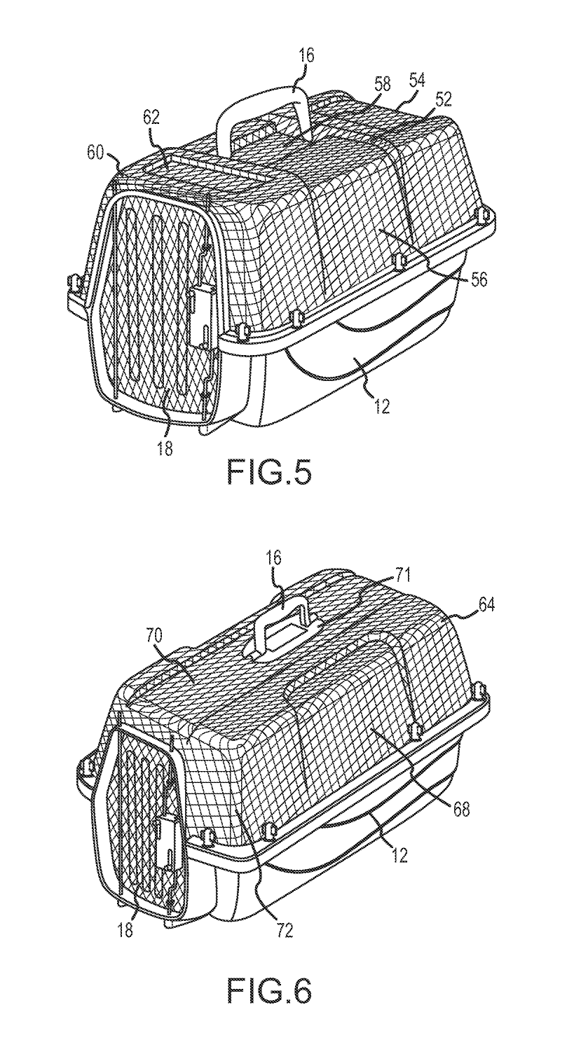

As shown in FIGS. 1 and 3, the top 14 may also include indentations 32 or grooves along is sides and/or top surface. The indentations 32 may add additional strength to the top 14. Further, the indentations 32 may act to help distribute stress along the material of the top 14, such that stresses may not concentrate in a particular area along the top 14. The indentations 32 may also act to help to prevent stresses from reaching the base 12, and/or allow stresses exerted on the top 14 to be distributed around the entire top 14. The indentations 32 may also add an aesthetic element to the top 14, and may be designed to match the indentations 38 on the base 12. However, in other embodiments, the indentations 32, 38 may be differently shaped. In some instances, the top 14 may include either in addition to or instead of the indentations 32, raised portions along its outer surface. Furthermore, in some embodiments, the indentations may be larger or longer than those illustrated in FIGS. 1 and 3, or may be configured in a variety of shapes (e.g., as shown in FIGS. 5 and 6).

The top 14 may also include a raised protrusion 11 extending from a cutout in the front face of the top 14. The front face may be raised upwards or cutout, such that when the top 14 is connected to the base 12, the combination of the cutout on the base 12 and the top 14 forms an opening into the kennel. The protrusion 11 generally extends past the end surface of the top 14, connecting the top 14 to the frame 20 and thus, in turn, to the door. The protrusion 11 may be below an upper surface of the top 14, such that the entryway created in the kennel 10 may not be as high as the entire height of the top 14 (when secured to the base 12).

The frame 20 may be attached to the protrusion and extend downwards, abutting the rim 15 surrounding the bottom edge of the top 14. The frame 20 may also for a top edge of the entryway for the kennel 10. The frame 20 may be formed from metal, but also may be made from any other sufficiently strong and durable material such as certain plastics The frame 20 may be attached to the top by cold-rolling the frame around the edge of the material, welding or other similar techniques. The frame 20 includes apertures (not shown) for receiving and securing the door 18 to the kennel. In one embodiment there are two apertures spaced along the upper surface of the frame 20; one aperture receives one rod supporting the door 18 and the other aperture receives the other rod. In these embodiments the frame 20 is sufficiently wide to receive both rods supporting the door 18. The frame 20 may be omitted and the door 18 may be attached directly to the top 14 or the frame 20 may be integrated with the top 14.

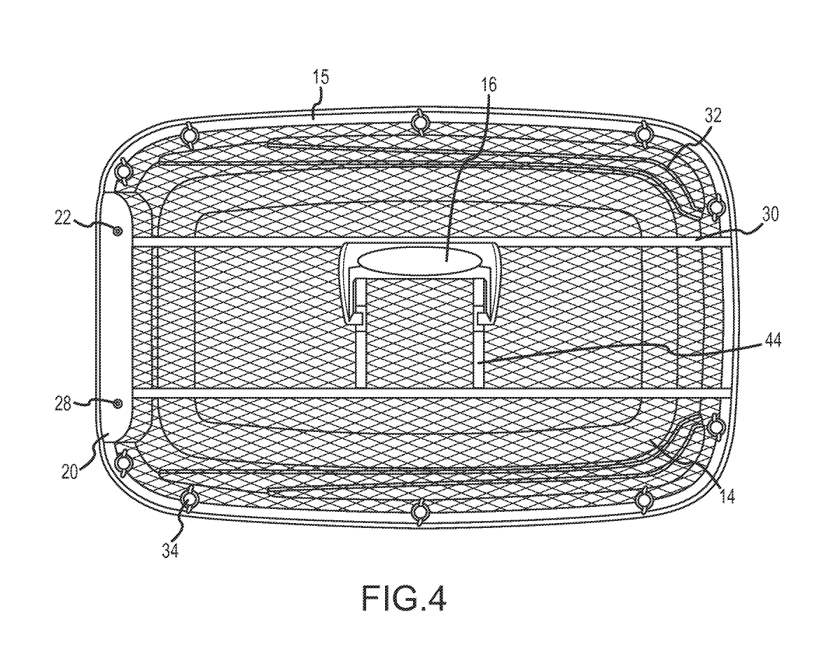

FIG. 4 is a top plan view of the top 14. Referring now to FIGS. 1 and 4, the top 14 may include ribs 30, 44. In some embodiments the top 14 may be stamped or created out of a single piece of mesh-like material. In such embodiments, the ribs 30, 44 may be additionally added to the top 14 to provide support. In other embodiments, the top 14 may be made from a number of different pieces secured together. In such embodiments, the ribs 30, 44 may join together the disparate pieces of the top 14. For example the ribs 30, 44 may be welded, molded or folded around the multiple pieces of material used to create the top 14. The ribs 30, 44 in these embodiments act nay facilitate forming the top 14 from multiple distinct pieces.

The ribs 30, 44 also may provide additional strength and/or structural support to the top 14. For example, the ribs 30, 44 may help prevent the material of the top 14 from warping or otherwise becoming misshapen. Further, the vertical ribs 44 extending between the horizontal ribs 30 may support the handle 16. As the handle 16 is pulled upwards (e.g. lifting the kennel 10), the ribs 44 receive the lifting force from the handle and may prevent this force from distorting the material of the top 14 by distributing the force along the vertical ribs 44. Although two sets of ribs 30, 44 have been illustrated, fewer or more ribs 30, 44 may be included along the top 14 to provide less or more strength and support. Also, the vertical ribs 44 may connect or attach to the horizontal ribs 30, and may extend past the horizontal ribs 30 or terminate at the connection point. For example, the vertical ribs 44 may extend down the sides of the top 14 in addition to being located on the upper surface. Similarly, the horizontal ribs 30 may end at the connection point for the vertical ribs 44, or, as shown in FIG. 4, may extend the entire length of the top 14.

As discussed above, the vertical ribs 44 may connect to the handle 16. In such an embodiment, the handle 16 may be configured to rotate to various positions around its axis. This may allow the handle 16 to rest along the upper surface of the top 14 when not being used, as well as extend upwards to provide a gripping area to more easily transport the kennel 10.

The rim 15 generally defines a bottom of the top 14. The rim 15 may surround the bottom edge of the top 14. The rim 15 typically has a substantially flat bottom surface and is complementary to the rim 13 along the base 12. For example, the rim 15 may be substantially flat and sit smoothly on top of the base rim 13. The rim 15 in some embodiments is made of metal; however, in other embodiments the rim 15 may be plastic or formed from another sufficiently strong material. The rim 15 may be formed around the edges of the material for the top 14, such that the rim 15 surrounds or sandwiches the end or edges of the top 14.

In some embodiments, the mesh material making up the top 14 may be wavy and/or slightly warped or misshapen, such that its pressed or stamped edges are not perfectly planar. In such an embodiment, the rim 15 may serve to flatten the top 14 at its connecting edge by sandwiching the ends of the mesh material. Additionally, the rim 15 may act to substantially conceal the shape of the mesh edge, such that the waves and/or warping are not readily visible. In some embodiments, the rim 15 may be shaped like an I-beam and have two flat surfaces connected to a vertical surface. The flat upper surface may form the upper surface of the rim 15 and the flat lower surface may form the mating surface for the rim 13 on the base 12.

When the kennel is being constructed, The top 14 mesh may be formed first and then the rim 15 may then be placed around the bottom edge of the top 14 and folded, thus sandwiching the top 14 material. This sandwiching may be done by cold-molding the rim 15 around the mesh. In some embodiments, the rim 15 may include apertures (not shown) spaced along its surface. The apertures allow the fasteners 34 to be inserted in order to connect the base 12 and the top 14.

The top rim 15 typically has a complementary shape to the base rim 13. When the top and bottom are to be attached to one another, the two rims 13, 15 are placed on top of one another and the fasteners 34 may be inserted into the apertures in both rims 13, 15. Once the fasteners 34 are inserted, the top 14 and the base 12 are secured together. In some embodiments, the fasteners 34 may be wing nuts, screws or the like. Additionally, the fasteners 34 may be designed to be quickly removable, allowing the kennel 10 to be disassembled, for instance for storage or the like. However, the top 14 and the base 12 may be secured together via other methods. For instance, the rims 13, 15 may be glued or otherwise permanently connected together.

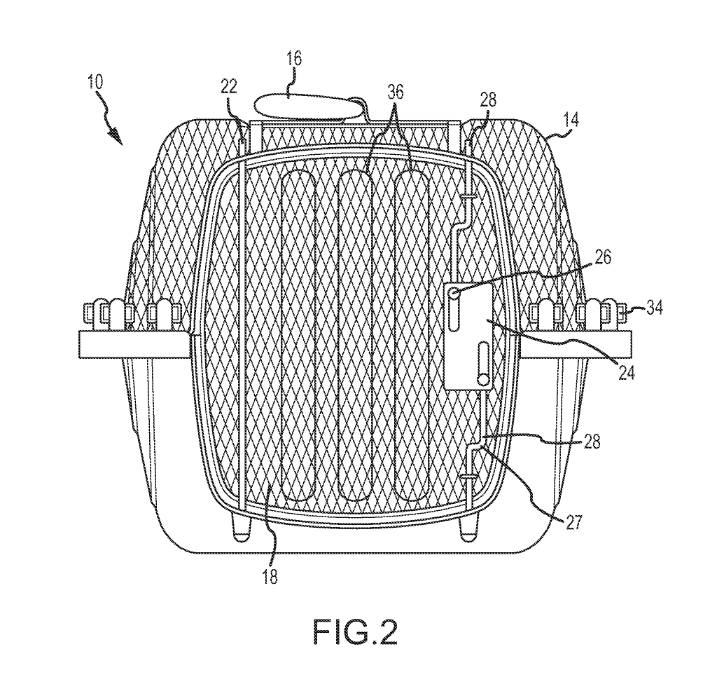

The door 18 fits within the opening created by the entryway when the top 14 and base 12 are connected. The door 18 opens to allow the animal to enter, and closes and latches to prevent the animal from exiting the kennel 10. Referring now to FIGS. 1 and 2, the door 18 has a hinge rod 22 and two latching rods 28 attached to a front surface of the door 18.

The door 18 may be made of the same or similar material to the top 14. In this embodiment, the door 18 is substantially see-through and includes a variety of apertures spaced along the surface. Additionally, the door 18 may include ridges 36 on its outer face. Similar to the indentations 32 along the top 14, the ridges 36 provide aesthetic appeal and may also more evenly distribute force along the door 18, thereby providing additional strength to the door 18. The door 18 may be configured to substantially fill the dimensions of the entryway, such that when the door 18 is in the closed position there is little or substantially no open space between the base 12, the top 14 and the door 18. The door 18 may shaped in a variety of designs, but typically is configured to substantially fit in the entryway created by the combination of the top 14 and the base 12.

The latching rods 28 are connected at a connection plate 24. The hinge rod 22 is attached to a first side of the door 18. A first end of the hinge rod 22 extends through the aperture in the frame 20 and a second end of the hinge rod 22 extends through an aperture in the protrusion 40 of the base. The door 18 may rotate around the hinge rod 22 to open and close. In some embodiments, the hinge rod 22 may rotate within each of the apertures as the door 18 rotates. A portion of the hinge rod 22 may extend past the top surface of the frame 22 and protrusion 40, such that the hinge rod 22 may rotate while remaining attached to the kennel 10. Thus, the length of the hinge rod 22 may be longer than the length of the entryway.

The latch rods 28 are used to open and latch the door 18. The latch rods 28 extend along the front face of the door 18 and each may include a bend 27 along their length. The latch rods 28 may be attached to the door 18 by aligning clips 25. The latch rods 28 may be moved upwards and downwards by knobs 26 attached to the end of each latch rod 28. The knobs 26 extend outwardly from the connection plate 24 and may be spaced such that a user can operate both knobs 26 at the same time with one hand. The top latch rod 28 extends through an aperture (not shown) located on the frame 20 and the bottom latch 28 extends through an aperture (not shown) located on the protrusion 40 on the base 12.

When the latches 28 are in the secured position and the door 18 is closed and is substantially prevented from opening, closing and the entry/exit to the kennel 10. To open the door 18, the user may squeeze or compress the two knobs 26 together, and, as the knobs 26 are connected to the latches 28, the top latch 28 will pull down and the bottom latch 28 will pull upwards. As the latches 28 are pulled together the ends of each latch 28 exit the apertures on the frame 20 and protrusion 40. After the ends of each of the latches 28 exit, the door 18 may rotate via the hinge rod 22. It should be noted that the door 18 may be rotated and/or secured to the kennel 10 in a variety of methods and by a variety of mechanical configurations. Thus, the disclosed rod/latch combination is simply one implementation.

FIG. 5 shows a second embodiment of the top that may be used with the base 12. In this embodiment the top 50 includes a handle 16 attached to its top surface, end indentations 54, 62, side indentations 56, and a raised front portion 60. The end indentations 54, 60 are depressed areas in the front and back of the top 50. The side indentations 56 run along the side and extend to the to surface of the top 50. The connection location of the side indentations 56 and raised surfaces 60 creates a wall 52, separating the indentations 58 from the surfaces 60. As with the top 14 in the previous embodiments (FIGS. 1-4), the top 50 may be created out of mesh material. Further, the top 50 may be made from a combination of mesh and other solid materials such as plastic. For instance, the raised surfaces 60 may be made plastic instead of mesh. In such an embodiment, the middle portion (e.g., side indentations 56) may offer visibility into the kennel 10, whereas the raised surfaces 60 may be solid and prevent visibility into the kennel 10.

In the present embodiment, the handle 16 may be secured to the material of the top 50 via a retaining plate (not shown) located on the inner side of the wall 52. This implementation helps to prevent the material of the top 50 from being pulled or warped when force is exerted on the handle 16. However, the handle 16 also may be attached to the top 50 via the ribs 30, 44, in a manner similar to the embodiment illustrated in FIG. 1. Furthermore, the retaining plate may be connected to the ribs 30, 44 or the like.

FIG. 6 depicts a third sample embodiment of the top. In this embodiment, the top 64 may include indentations 70 longitudinally extending from the front end to the back end of the top, as well as side indentations 68 on both sides of the top. The top 60 may be made of similar material to the top 14 that is shown in FIGS. 1-4. Additionally, as with the top 50 illustrated in FIG. 4, the top 60 may include plastic or other materials besides the mesh material. For instance, the raised portions 72 may be formed of plastic. The handle 16 may be secured to the top 64 by a plate 71 connected to the upper surface of the top 64. This configuration may help to distribute any force exerted on the handle 16, when it is lifted, across the entire top 64, instead of maintaining it in a relatively small area, thus reducing the chances that the material will rip or tear.

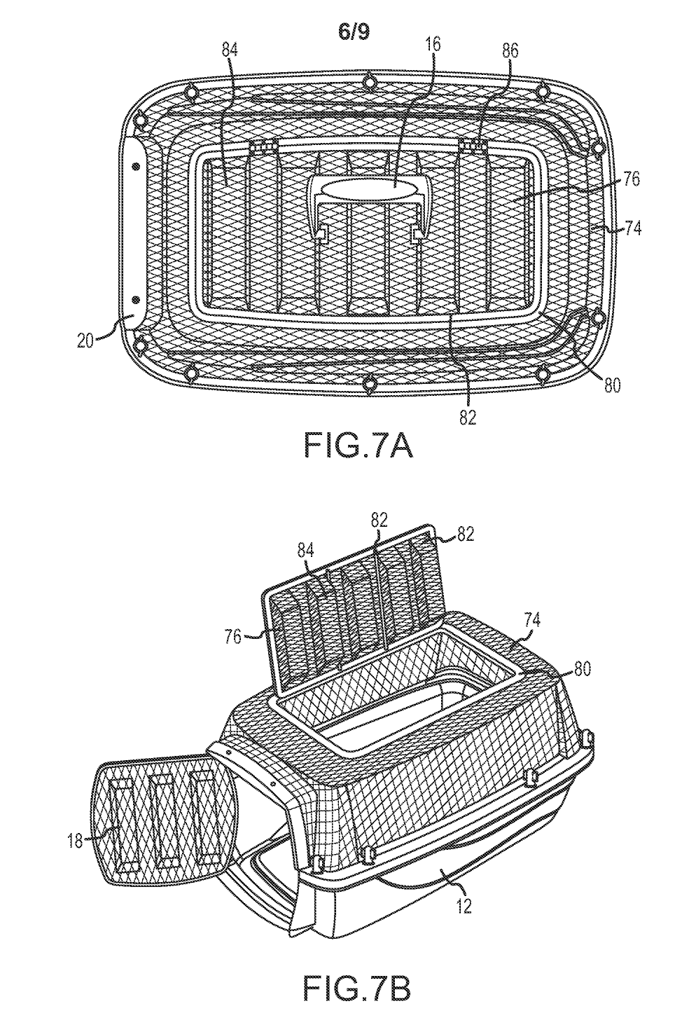

FIG. 7 shows a fourth embodiment of a top to be used with the base 12. In this embodiment the top 74 includes a hatch 76 on an upper surface. The hatch 76 acts as a second entry/exit for the animal. The hatch 76 may be used in combination with the door 18 or in place of the door 18. In embodiments where the door 18 maybe omitted, the front end of the top 14 and the base 12 may be constructed similarly to the back end, i.e. the openings/cutouts forming the entryway may be omitted. The hatch 76 may be used rather than the door 18, as some animals may not want to be removed from the kennel 10 once inside. As in some embodiments the kennel 10 may be small and/or difficult for a person to enter, the hatch 76 allows a person to more easily reach inside the kennel 10. This allows the person to grab the animal without having to crawl or otherwise enter the kennel 10 via the door 18.

The hatch 76 is secured along a hinge and, in some embodiments, rotates upwards along a longitudinal side axis. The hatch 76 secures to a lip 80 located around the aperture in the top 74. The lip 80 may be created in a fashion similar to the ribs 30, 44, in that the lip 80 may be made of metal sandwiched around the material of the top 74. The hatch 76 may be also surrounded by a lip 82, such that when the hatch 76 is in the closed position the lips 80, 82 are aligned with respect to one another.

Similar to the door 18, the hatch 76 may include latching rods 86 and ridges 84. The ridges 84 act to provide additional strength and support to the material of the hatch 76, which may be the same as the material for the door 18. Additionally, the latching rods 86 may be used to secure the hatch 76 in a closed position. In the closed position the latching rods 86 may extend underneath the lip 80 on the top 74, such that the hatch 76 is prevented from extending upwards. The latching rods 86 may be pushed back so as to no longer rest underneath the lip 80. Once this is done, the hatch 76 may be rotated upwards. It should be noted that, although the hatch 76 has been illustrated as rotating along its longitudinal side, in other embodiments the hatch 76 may rotate on the shorter side, e.g., the side facing the front and back of the kennel 10. It also should be noted that, although ribs are not illustrated in this embodiment, they may be included in order to provide additional strength and support to the top 74.

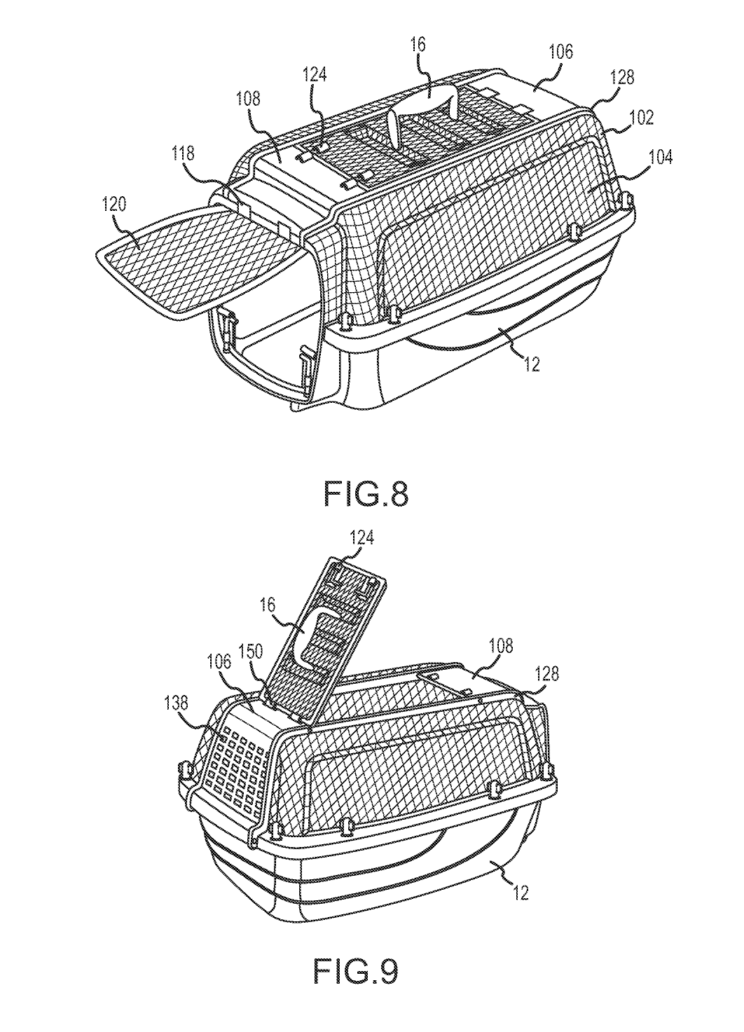

FIGS. 8 and 9 illustrate a fifth embodiment of a top, as well as a second embodiment for a door. The illustrated top 102 has a hatch 126 on its upper surface. In this embodiment, the hatch 126 is similar to the hatch 76 illustrated in FIG. 7. However, unlike the hatch 76 of FIG. 7, this hatch 126 rotates along its shorter length, e.g., the side along the front or rear of the kennel 10. The hatch 126 has a handle 16 connected in a middle area of the upper surface of the hatch 126. The hatch 126 connects to the top 102 via a hinge 124 secured to a spacer 108 between the frame 20 and the hatch and may include latching rods 122 spaced at the rear end of the hatch 126. In other embodiments, the latching rods 22 may be spaced at other ends of the hatch 126. For instance, if the hatch 126 were to rotate along its back axis, the latching rods 122 may be placed on the front end of the hatch 126. The latching rods 122 operate similarly to the latching rods 28 shown in FIGS. 1-4 and previously described.

Additionally, the hatch 126 may include latches and/or hinges 124 located on the front end or back of the kennel 10. As with the top 14 illustrated in FIG. 7, the hatch 126 may be configured to rotate in a variety of directions, e.g. along different sides of the hatch 126.

The top 102 may include two side panels 104 created from a mesh material, similar to the top 14 illustrated in FIG. 1. In this embodiment, the two side panels 104 are attached to the hatch 126 and two spacers 106, 108. The hatch 126 connects to the side panels 104 via a rib 128 that runs the length of the side panels 104 and is disposed between the side panels 104 and the hatch 126. The rib 128 may be substantially similar to the ribs 30, 44 illustrated in FIGS. 1-4, and provides for a connection between the hatch 126 and side panels 104.

The top 104 may include a frame 123, similar to the frame 20 illustrated in FIGS. 1-4. In this embodiment, however, the frame 123 is integrated with the spacer 108, such that the spacer 108 spans the hatch 126 and acts as a portion of the frame 123. In other embodiments, the spacer 108 may be omitted or the dimensions may be altered, such that the spacer 108 does not form a portion of the frame 123.

The spacers 106, 108 may be solid or they may include apertures or the like. In some embodiments the spacers 106, 108 may be made from a different material from the side panels 104. In such embodiments, the spacers 106, 108 may be plastic, metal or the like. Additionally and as illustrated in FIG. 9, the spacers 106, 108 may include apertures 138 disposed along the surface. The apertures 138 create a window-like effect for the animal within the kennel 10. Additionally, the apertures 138 on the spacer 106 allow for more air circulation and visibility into the kennel 10.

In the embodiment illustrated in FIGS. 8 and 9, the door 120 may be generally similar to the door 18 illustrated in FIGS. 1-4. However, the door 120 in these embodiments may be rotated about the top horizontal axis of the frame 123. The door 120 swings upwards in order to open, versus the door 18 in other embodiments (such as that of FIGS. 1-4) that swings outwards to open. It should be noted that either door 18, 120 may be configured to rotate/swing in any manner. Here, the door 120 rotates along a hinge 118 located on the frame 123.

As the door 120 rotates upwards, it may be configured to latch at a bottom area along the protrusion 40 of the base 12. In this embodiment, the protrusion 40 includes latches 119 on a bottom upper surface. The latches 119 secure the door 120 when the door 120 is the closed position, substantially preventing an animal within the kennel 10 from exiting the kennel 10 via the entryway. It should be noted that the door 120 may latch in a variety of different manners and/or locations, and this is simply one embodiment.

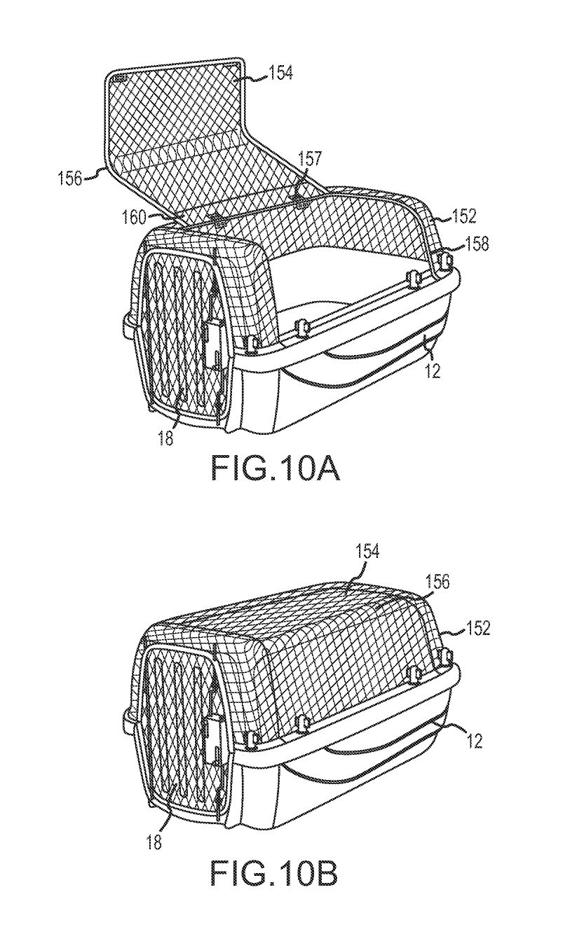

FIGS. 10A and 10B illustrate a sixth embodiment of the top. In this embodiment the top 152 includes a bent panel 154 and two end panels 160. The top 152, including the bent panel 154 and the two end panels 160, is a mesh material, and is constructed similarly to the top 14 illustrated in FIGS. 1-4. The bent panel 154 forms a portion of the upper surface of the top 152, as well as a portion of the side panel, as the bent panel 154 curves or bends downwards at the bend point 156. The bent panel 154 is therefore shaped as half a rectangle or square shape in that it includes a top surface and a side surface. The bent panel 154 attaches to the end panels 160 along a rib 158. The rib 158 is generally similar to the ribs 30, 44 illustrated in FIGS. 1-4. Additionally, in these embodiments, the end panels 160 may be formed as a unitary piece and form an additional side panel, i.e. the two end panels 160 may connect to each other across a side of the kennel 10. However, in other embodiments, the end panels 160 may connect to an additional side panel (not shown), and the side panel may be a different material from the side panels. The hinge 157 may be connected to the side panel (not shown) or to a rib joining the side panel and the bent panel 154.

The bent panel 154 is configured to rotate along a hinge 157 located on it's upper surface. A portion of the top and side of the kennel 10 may be open when the bent panel 154 is rotated upwards into the open position. This allows a user to quickly access the animal placed within the kennel 10, as most of the inner cavity of the kennel 10 may be exposed when the bent panel 154 is in the up position. This may be useful as sometimes animals may retreat to a back area of the kennel 10 when a person attempts to remove the animal from the kennel 10. As the bent panel 154 exposes most of the inner portion of the kennel 10 the animal may easily be retrieved without a substantial amount of effort. The bent panel 154 may function as the door/entry way to the kennel 10 or may be in addition to the door 18 for the kennel.

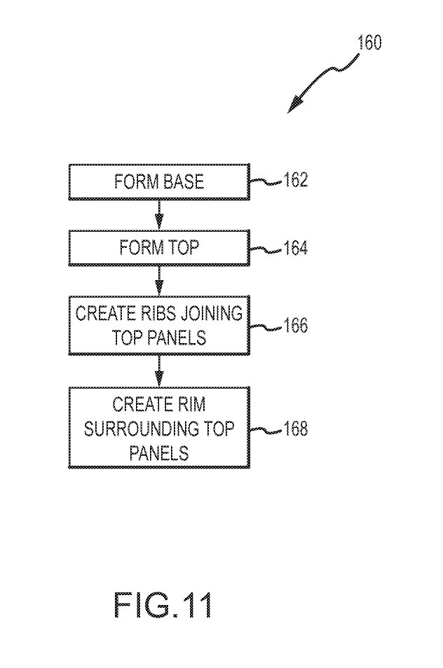

FIG. 11 is a flow chart illustrating operations that may be used to form the kennel 10. Operations 160 begin with operation 162 forming the base 12. This operation 162 may be done by injection molding or similar methods. The next operation 164 forms the top 14. In some embodiments the top 14 may be assembled by combining different panels together, in these embodiments, each panel may be created during this operation 164. However, in other embodiments, the top 14 may be unitary element, in this embodiment the entire top 14 is created during this operation 164. In this operation 164 the material for the top is stamped to form a mesh design, including apertures spaced throughout the top 14. It should be noted that the size of the apertures and/or the size of the wires forming the mesh structure may be altered to be fine or thicker, depending on the desired visibility for the kennel 10. Additionally, during this operation 164 the indentations 32 and other structures for the top 14 may be created into the mesh structure. It should be noted that the door 18 may be created by a similar operation to this operation 164.

In the next operation 166 the ribs 30, 44 are created. In the embodiments where the top 14 is constructed from a number of different panels, the ribs 30, 44 may join each of the panels together to form the top 14. However, this step may be omitted, for example if the ribs 30, 44 are omitted from the kennel 10, i.e. the top 14 is a unitary element. After operation 166, the next operation 168 creates the rim 15. The rim 15 may be formed by cold-molding material around the end portion of the top 14. This may be done by bending the material around the ends of the top 14 essentially sandwiching the ends of the top 14 within the rim 15 material. In these embodiments, the material may be metal, such as steel, aluminum or the like.

The foregoing describes some example embodiments to achieve a kennel for animals. Although the present invention has been described with reference to illustrated embodiments, persons skilled in the art will recognize that changes may be made in form and detail without departing from the spirit and scope of the invention. Indeed, in other embodiments, the process for creating the top and the design of the top may be used in other applications besides pet kennels and crates, for example perishable food items or the like. Furthermore, it should be appreciated that other components may be added to the kennel. For example, water/food bowls may be integrated into the kennel 10, or a padding area may be included. Accordingly, the specific embodiments described herein should be understood as examples and not limiting the scope of the disclosure.

What is claimed is:

1. A kennel for an animal comprising
a base;
a base rim extending from the base and surrounding an upper perimeter of the base;
a mesh top;
a top rim surrounding a bottom perimeter of the top and configured to align with the bottom rim;
at least one fastener configured to secure the top rim to the bottom rim; and
a door rotatably connected to the base and the top.

2. The kennel of claim 1, wherein
the base rim further comprises at least one base aperture configured to receive a portion of the least one fastener;
the top rim further comprises at least one top aperture configured to receive a portion of the at least one fastener; and
the at least one base aperture is configured to be substantially aligned with the at least one top aperture when the base and the top are secured together.

3. The kennel of claim 1, wherein the mesh top is a stamped metal mesh.

4. The kennel of claim 1, wherein the top rim is configured to sandwich the mesh top, such that an edge of the mesh top is surrounded by a portion of the top rim.

5. The kennel of claim 4, wherein the top rim is formed by cold-molding the top rim material around an edge of the mesh top.

6. The kennel of claim 5, wherein the top rim is metal.

7. The kennel of claim 1, wherein the door is a mesh material and the door further comprises at least one ridge on an outer surface.

8. The kennel of claim 1, wherein the top further comprises at least one longitudinal indentation running along a side panel of the top.

9. The kennel of claim 1, further comprising a handle operatively connected to the top.

10. The kennel of claim 1, further comprising a hatch operatively connected to an upper surface of the top, wherein the hatch is configured to rotate.

11. The kennel of claim 10, wherein the hatch further comprises
a handle operatively connected to an upper surface of the hatch;
a hinge operatively connected to the hatch and the top, wherein the hatch is configured to rotate via the hinge; and
a latch operatively connected to the hatch, wherein the latch is configured to secure the latch to the top and substantially prevent the hatch from rotating when the latch is in a first position.

12. The kennel of claim 1, wherein the top further comprises
at least one end panel; and
a bent panel, wherein the bent panel is configured to rotate relative to the least one end panel and when the bent panel is in a first position the top is open and when the bent panel is in a second position the top is closed.

13. A crate for an animal comprising
a base;
a top configured to be secured to the base, wherein the top comprises
a top panel;
a first side panel;
a second side panel;
wherein the top panel, the first side panel and the second side panel are operatively connected together; and
a lip operatively connected to the first and second side panels, wherein the lip receives and substantially surrounds an edge of a bottom of the first side panel and an edge of the second side panel.

14. The crate of claim 13, wherein the base further comprises a rim extending around a perimeter of the base, wherein the rim is configured to have substantially the same upper surface area dimensions as the lip.

15. The crate of claim 14, wherein
the rim further comprises rim apertures spaced along the upper surface area of the rim; and
the lip further comprises lip apertures spaced along an upper surface of the lip, wherein the rim apertures and the lip apertures are configured to be substantially aligned when the top and the base as secured together.

16. The crate of claim 13, further comprising a door operatively connected to the base and the top, wherein the door comprises
a hinge rod extending from a top end of the door to a bottom end of the door, wherein the hinge rode is operatively attached to the top and the base; and
at least one latching rod, wherein the latching rod is selectively secured to the top and the base, and when the at least one latching rod is in a first position the door is unlocked and when the latching rod is a second position the door is locked.

17. The crate of claim 16, wherein the door and the top are stamped metal mesh.

18. The crate of claim 13, further comprising at least one fastener configured to secure the top and the base together.

19. The crate of claim 13, further comprising a handle operatively connected to the top panel.

20. A method for constructing a kennel for an animal comprising the steps of
forming a plastic base;
stamping a mesh material forming a top, wherein the top comprises
an upper panel; and
at least one side panel;
forming at least one rib, wherein the rib secures the upper panel and the least one side panel together; and
surrounding a bottom edge of the at least one side panel with a metal material and folding the metal material on top of the bottom edge creating a rim around a bottom edge of the least one side panel.
